(19) United States
(12) Patent Application Publication
(10) Pub. No.: US 2012/0329014 A1
(43) Pub. Date: Dec. 27, 2012

(54) Essay System

(76) Inventor: Vu Hong Pham, La Palma, CA (US)

(21) Appl. No.: 13/168,325

(22) Filed: Jun. 24, 2011

(51) Int. Cl. G09B 5/00

(52) U.S. Cl. 434/169

(57) ABSTRACT

An interactive computer based essay system that prompts students, step-by-step, field-by-field, to write a completed essay is disclosed. The system breaks down the essay-writing process into simple steps using unique processes and algorithms. It also integrates several external elements to ensure student success with writing. The essay system follows three key steps: 1) Follow the instructions based on the three key algorithms: “ABCD Algorithm”, “Advanced TEEEEC Algorithm”, and “Thesis Algorithm”; 2) Write an essay; and 3) Coach provides feedback. The platform allows for progress tracking so that customers know how students are performing with the system at all times. Parents and instructors, therefore, have the ability to gauge and guide improvement, as well as identify critical areas of focus for the student. Coaches are readily available to provide feedback.

### BACKGROUND OF THE INVENTION

This invention relates to an interactive computer based essay system that prompts students, step-by-step, field-by-field, to write a completed essay is disclosed. The system breaks down the essay-writing process into simple steps using unique processes and algorithms. It also integrates several external elements to ensure student success with writing.

Traditionally, educators have struggled with the arduous task of teaching writing skills to students. One of the most difficult areas to teach is the writing of essays. Numerous attempts at providing computer assisted essay instruction have had mixed and limited success. Often, the methods and their lack of success discourage students from acquiring this very important skill.

The present invention has addressed the shortcomings of previous attempts and provides a novel, innovative, interactive, and more effective system for teaching essay writing.

### SUMMARY OF THE INVENTION

Given the above deficiencies of prior art, there is a need for a more effective essay writing system that allows students to interact with writing coaches and undergo a step-by-step, field-by-field, writing system.

Advantageously, the present invention achieves this goal by way of a unique essay-writing system that breaks the writing process down into various processes and algorithms.

The present invention revolves around three key elements: 1) students; 2) writing coaches; and 3) the essay writing platform.

The essay system follows three key steps: 1) Follow the instructions based on the three key algorithms: “ABCD Algorithm”, “Advanced TEEEEC Algorithm”, and “Thesis Algorithm”; 2) Write an essay; and 3) Coach provides feedback.

Key differentiators of the present invention from traditional systems include: 1) Multiple Mastery Model; 2) On-Demand Service; 3) Progress Tracking; and 4) Developing the Foundation for Students' Futures.

With regards to the first differentiator, the unique Multiple Mastery Model of learning combines two proven models of learning: Multiple Intelligence and Mastery Learning. The Multiple Mastery Model assumes that students should master one subject before advancing to another one, yet learn this subject in multiple ways. We draw from the Multiple Intelligence approach, which demonstrates that people possess different types of intelligence—IQ (Intelligence Quotient) only measures one type of intelligence. Students can display high interpersonal intelligence, as well as areas such as musical, linguistic, naturalistic, spatial or body/physiological intelligence, among other types. We couple this with Mastery Learning. Research shows that Mastery Learning increases retention and shows educational results. Rather than simply moving from one lesson to the next, Mastery Learning means focusing on one lesson or skill at a time (in this case essays) and mastering it. Our Multiple Mastery Model delivers Multiple Intelligence assessments and forms of learning, combined with one focused topic—writing essays.

With regards to “On-Demand Service”, the online platform of the present invention serves students with on-demand with 24/7 access. Not only do students have the capability of accessing the software at all times, but they also get extremely quick turnaround for essay feedback and editing. The present invention provides open office hours, tutorials, demos and webinars that enable students to obtain all of the information they need with the click of a mouse.

With regard to “Progress Tracking”, the present invention allows customers to know how students are performing by tracking regular progression. Students can see how they've improved over time with progress reports and updated tracking. Parents and instructors thereby have the capability to gauge and guide improvement, as well as identify critical areas of focus for the student.

With regard to “Developing the Foundation for Students' Futures”, the present invention lays the groundwork for future instances and opportunities of written communication that students may encounter including college admissions essays, scholarship applications, resumes, job applications and cover letters.

The present invention also utilizes external elements to ensure student success with writing, including: 1) the “ABCD Algorithm”; 2) the “Advanced TEEEEC Algorithm”; and the “Thesis Algorithm”.

The “ABCD Algorithm” is broken down to mean: A: Answer the question directly; B: Brainstorm; C: Categorize; and D: Demonstrate (with examples). The “ABCD Algorithm” is usually a linear process, which means that Steps A-D are performed in that exact order. This is especially the case when the essay prompt asks a question in the form of “Who,” “What,” “Where,” and “When.” Sometimes, however, when questions are in the form of “Why” or “How,” the “Brainstorm” and “Categorize” steps may have to be performed before the “Answer the question directly” step.

The “Advanced TEEEEC Algorithm” is broken down to mean: T: Topic Sentence; E: Example #1; E: Explanation #1; E: Example #2; E: Explanation #2; C: Concluding Sentence.

The “Thesis Algorithm” uses steps A and C of the ABCD outline to form a thesis in a clear and easy manner. It combines part A and the main categories of Part C in the outline to create a thesis that can satisfy the “Thesis Test.”

### BRIEF DESCRIPTION OF THE DRAWINGS

The accompanying drawings, which are incorporated into and constitute a part of this specification, illustrate one or more embodiments, and together with the detailed description, serve to explain the principles and implementations of the invention. In the drawings:

FIG. 1 illustrates a flow chart depicting the three key elements that the present invention revolves around: 1) students; 2) writing coaches; and 3) the essay writing platform.

FIG. 2 illustrates a flow chart depicting the three key steps of the present system: 1) Follow the instructions based on the three key algorithms: “ABCD Algorithm”, “Advanced TEEEEC Algorithm”, and “Thesis Algorithm”; 2) Write an essay; and 3) Coach provides feedback.

FIG. 3 illustrates the essay system process flow for the student user.

FIG. 4 illustrates the writing pyramid.

FIG. 5 illustrates the “ABCD Algorithm” outline process.

FIG. 6 illustrates a meta-view of essays using the “Advanced TEEEEC Algorithm.”

FIG. 7 illustrates the thesis algorithm.

### DETAILED DESCRIPTION OF THE PREFERRED EMBODIMENT(S)

Traditionally, essays were all either written by hand or composed on paper. With the invention of the computer, writers began typing their essays on word processing software. The present invention addresses the shortcomings of composing essays on paper, by hand, or even on word processing software by creating a novel process for composing essays with a computer-based structure.

The present invention, however, breaks down the essay-writing system into simple steps using various processes and algorithms. It prompts students, step-by-step, field-by-field, to write a complete essay from start to finish.

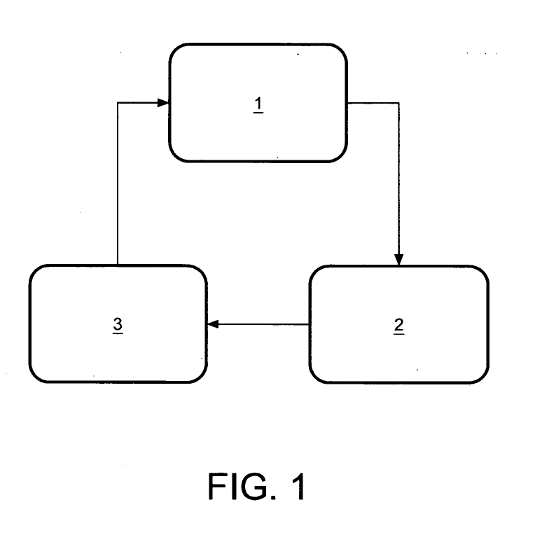

Referring now to FIG. 1, a flow chart depicting the three key elements of the present invention is illustrated. In this embodiment of the invention, the three elements include students 1, writing coaches 2, and the essay writing platform 3. Students sign up for the essay system to learn the proper techniques for composing an essay. After they have completed composing their essays, they submit the final products through the essay writing platform. Writing coaches are then readily available to correct the submitted essays and provide feedback.

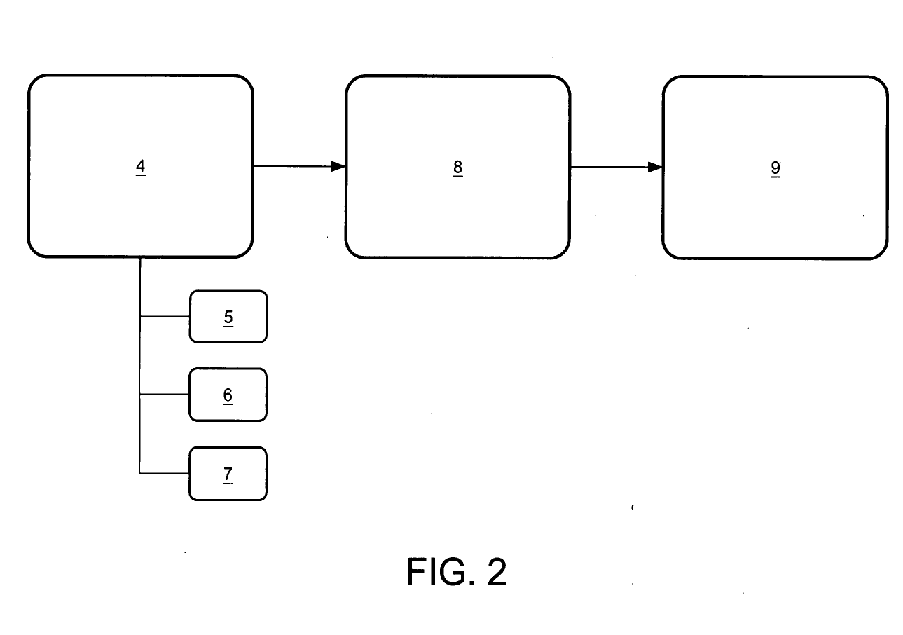

Referring now to FIG. 2, a flow chart depicting the three key steps of the present system is illustrated. In this embodiment of the invention, the three key steps include “Follow the instructions based on the three key algorithms” 4: “ABCD Algorithm” 5, “Advanced TEEEEC Algorithm” 6, and “Thesis Algorithm” 7; “Write an essay” 8; and “Coach provides feedback” 9.

Still referring to FIG. 2, in an embodiment, the students follow the processes and algorithms in order to write an essay. The students also follow the instructions based on the “ABCD Algorithm” 5, “Advanced TEEEEC Algorithm” 6, and “Thesis Algorithm” 7, which will be explained in more detail thereafter. The platform allows for progress tracking so that customers know how students are performing with the system at all times. Parents and instructors, therefore, have the ability to gauge and guide improvement, as well as identify critical areas of focus for the student. Coaches are readily available to provide feedback.

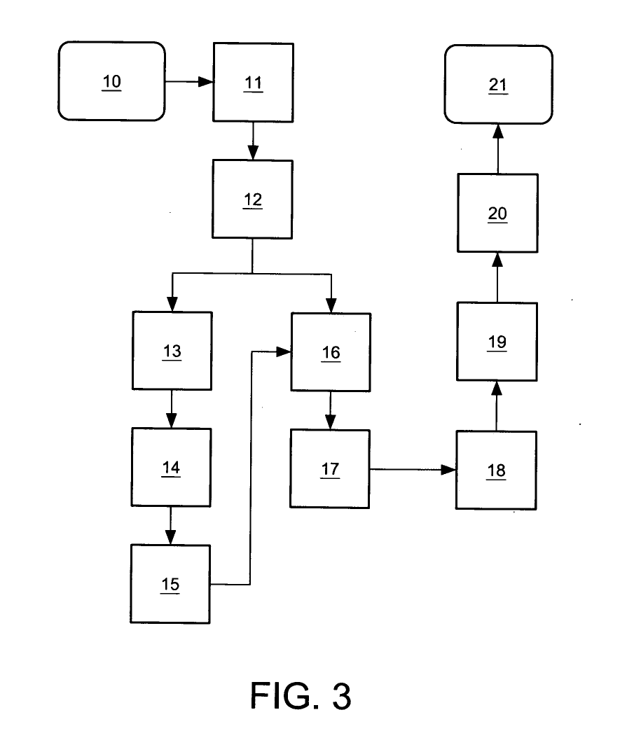

Referring now to FIG. 3, the essay writing system process flow for the student user is illustrated. The student begins at “Start” 10, proceeds to the “Store Front” 11, and then proceeds to “Student Log-In” 12 to log in. If the student is a “First time student” 13, then the “Parents need to set up profile” 14. After setting up the profile, the “Parents make payment” 15 for the essay system. Alternatively, if the student is already a registered student, then the student proceeds to “Current student log-in” 16 and then proceed directly to the “Dashboard” 17, where they receive instructions on composing the essay and actually compose the essay. Then, the “Student submits essay” 18 and the “ES system logs incoming essays” 19. Finally, the coaches grade the essays and the “ES system returns graded essay” 20, which leads to the “End” 21.

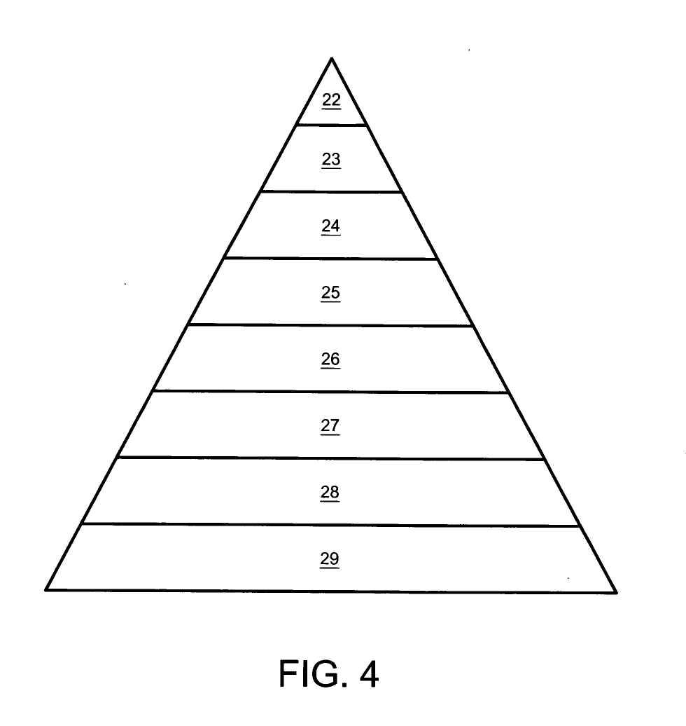

Referring now to FIG. 4, the writing pyramid is illustrated. The pyramid contains eight elements, including: style 22, vocabulary 23, grammar 24, editing 25, introductions and conclusions 26, thesis statements 27, paragraphs 28, and brainstorming and outlining 29. The first four elements can take a large quantity of time to develop, and only yield limited results. The last four elements can also take a large quantity of time to learn but will, however, yield a much larger improvement and better results within a smaller time frame. Therefore, the present invention focuses on the last four elements rather than the first four.

The present invention also utilizes external elements to ensure student success with writing, including: the “ABCD Algorithm” 5, the “Advanced TEEEEC Algorithm” 6, and the “Thesis Algorithm” 7.

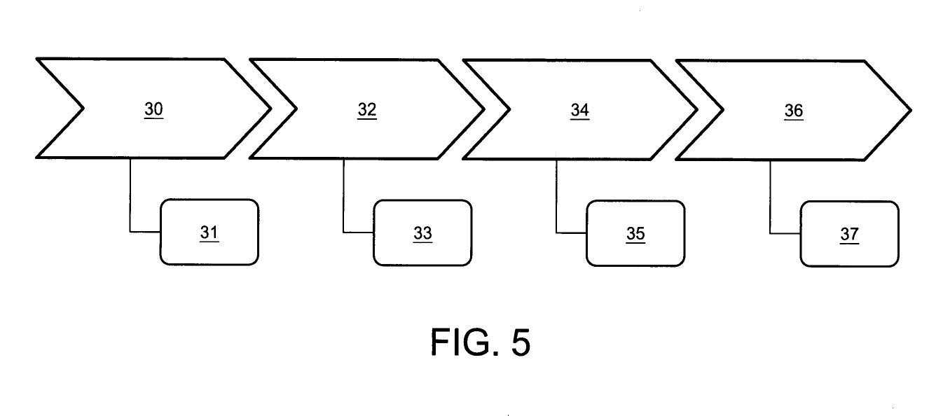

Referring now to FIG. 5, the “ABCD Algorithm” 5 outline process is illustrated. The “ABCD Algorithm” 5 stands for A 31—“Answer the question directly” 30, B 33—“Brainstorm” 32, C 35—“Categorize” 34, and D 37—“Demonstrate (with examples)” 36. The “ABCD Algorithm” 5 is usually a linear process, which means that Steps A-D are performed in that exact order. This is especially the case when the essay prompt asks a question in the form of “Who,” “What,” “Where,” and “When.” Sometimes, however, when questions are in the form of “Why” or “How,” the “Brainstorm” and “Categorize” steps may have to be performed before the “Answer the question directly” step.

Still referring to FIG. 5, the primary instruction of this process is to A 31—“Answer the question” 30. Thesis statements are created after the body of the essay is completed and finalized later in the software. The introduction and conclusion paragraphs are then created after the thesis statement is created.

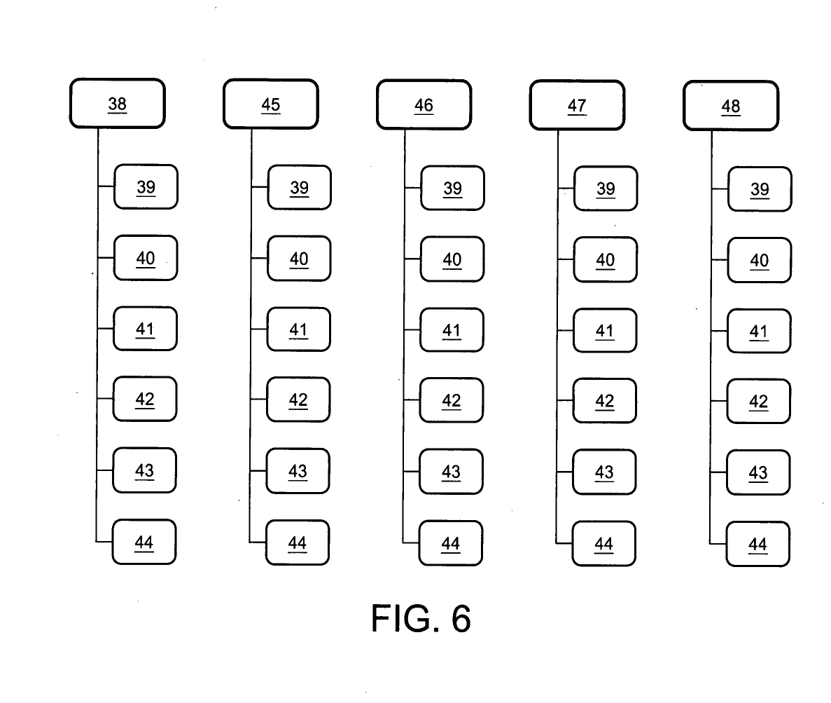

Referring now to FIG. 6, a meta-view of essays using the “Advanced TEEEEC Algorithm” 6 is illustrated. The “Advanced TEEEEC Algorithm” 6 stands for: T: Topic Sentence 39; E: Example #1 40; E: Explanation #1 41; E: Example #2 42; E: Explanation #2 43; C: Concluding Sentence 44. An essay typically contains five parts: Introduction 38, Paragraph 2 45, Paragraph 3 46, Paragraph 4 47, and Conclusion 48. Each of the five parts is further broken down using the “Advanced TEEEEC Algorithm” 6. Therefore, the Introduction has a topic sentence 39, two examples 40 and 42, two explanations 41 and 43, and a concluding sentence 44. The second paragraph 45 also follows the same structure. The third and fourth paragraphs 46-47 also follow the same structure. Finally, the conclusion 48 also follows the same structure.

Still referring to FIG. 6, the “Advanced TEEEEC Algorithm” 6 requires examples and an explanation of each of the examples. The essay writing software allows users to literally categorize or sort through their reasons after they are formed in order to create paragraphs. Subsequently, students work towards building the essay.

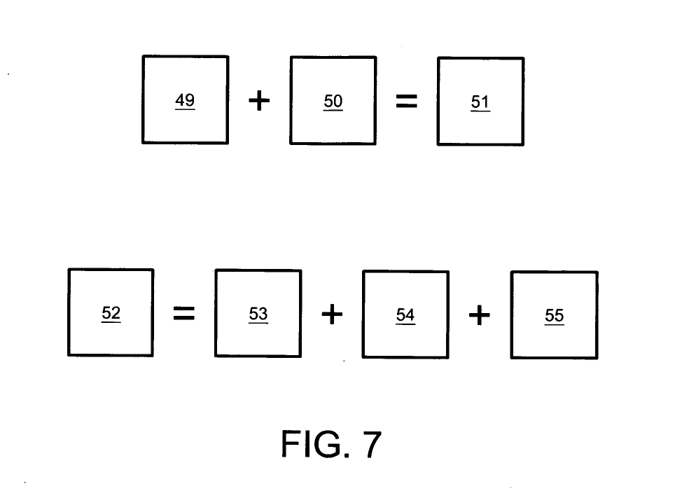

Referring now to FIG. 7, a case example of thesis statements is illustrated. The “Thesis Algorithm” 7 uses steps A 49 and C 50 of the ABCD outline 5 to form a thesis 51 in a clear and easy manner. It combines part A 49 and the main categories of Part C 50 in the outline to create a thesis 51 that can satisfy the “Thesis Test.” In an embodiment, the thesis statement describes the argument, or what the student believes, suggests the evidence, and structures the argument.

The thesis formula in the present invention includes an answer plus categories. Students combine their previous answers from the “Answer” and “Categorize” fields to create a single thesis. Universal methods apply to many types of essays but this essay system mainly provides for the three algorithms as previously discussed: ABCD 5, TEEEEC 6, and Thesis Formula 7.

In another embodiment of the present invention, interactive software is incorporated, including pop-up tool tips that are embedded in the software. The essay writing system also provides for step-by-step instructions and examples.

In yet another embodiment of the present invention, mnemonics are utilized to aid users in remembering methods and structures. The essay writing system provides students with algorithms and challenges students to think first by using the ABCD outline 5. Then, the system focuses on how to determine the content of each of the paragraphs. After each of these steps is completed, the students then work towards building the essay.

In yet another embodiment of the present invention, the essay writing system features a unique Multiple Mastery Model of learning, which integrates two proven models of learning: Multiple Intelligence and Mastery Learning. The Multiple Mastery Model assumes that students should master one subject before advancing to another one, yet learn this subject in multiple ways. It draws from the Multiple Intelligence approach, which demonstrates that people possess different types of intelligence—IQ (Intelligence Quotient) only measures one type of intelligence. Students can display high interpersonal intelligence, as well as areas such as musical, linguistic, naturalistic, spatial, or body/physiological intelligence, among other types.

In yet another embodiment of the present invention, Mastery Learning research shows that students should place their energies on one lesson at a time, and master it, before moving to others. The present invention provides students with different types of teaching and learning, while focusing exclusively on the single topic of essay writing—one of the most-critical skills needed in school and career. The Multiple Mastery Model offers Multiple Intelligence and various forms of learning, combined with one focused topic.

What is claimed is:

1. A computer based system for composing an essay comprising:
a thesis formula;
outlining capability;
a paragraph writing algorithm (Advanced TEEEEC Algorithm); and
multiple mastery method.

2. The system of claim 1, further comprising interactive software, such as pop-up tools, that are embedded into the software.

3. The system of claim 1, further comprising the use of mnemonics to aid users in remembering methods and structures of composing an essay.
